(19) United States
(12) Patent Application Publication
(10) Pub. No.: US 2016/0139628 A1
(43) Pub. Date: May 19, 2016

(54) User Programable Touch and Motion Controller

(71) Applicants: Li Bao, San Diego, CA (US); Lyle Philip Arenson, San Diego, CA (US); Jonathan Schroeder, Escondido, CA (US)

(72) Inventors: Li Bao, San Diego, CA (US); Lyle Philip Arenson, San Diego, CA (US); Jonathan Schroeder, Escondido, CA (US)

(21) Appl. No.: 14/940,787

(22) Filed: Nov. 13, 2015

Related U.S. Application Data
(60) Provisional application No. 62/079,347, filed on Nov. 13, 2014.

(51) Int. Cl. G06F 1/16; G06F 3/16; G06F 3/0488; G06F 3/0482; G06F 3/041; G06F 3/0346

(52) U.S. Cl. CPC G06F 1/163; G06F 3/0412; G06F 3/0416; G06F 3/0346; G06F 3/04883; G06F 3/0482; G06F 3/167; G06F 2203/04104; G06F 2203/04808

(57) ABSTRACT

A wearable device having a display and a touchscreen is disclosed. The device is capable of interfacing with and controlling remotely controllable devices. The device is capable of sensing swipes, touches, and gestures, which are mapped to custom command and control functions. Swipes and touches may be with one finger or multiple fingers simultaneously, Gestures may be any motion limited only by the sensitivity of the motion sensing devices. In alternative embodiments, the device further consists of a speaker and microphone to allow spoken commands to be used in conjunction with, or replace, swipe, touch, and gestures to enhance the efficiency or ease of use of the device. In other alternative embodiments, the device may connect to a remote controllable device through a cloud, internet, or cellular network.

### RELATED APPLICATIONS

This application claims the benefit of, and priority to, U.S. Provisional Patent Application No. 62/079,347 entitled “User Programmable Touch and Motion Controller”, filed on Nov. 13, 2014, and currently co-pending.

### FIELD OF THE INVENTION

The present invention pertains generally to wireless motion and touch sensitive controllers for use in controlling local or remotely controllable equipment. More particularly, the present invention pertains to a wearable programmable device having a touch sensitive surface sensitive to single location touches as well as swipes, rotations, and taps using one or more touch locations simultaneously. The present invention also pertains to a wearable programmable device having integrated motion sensors to sense the user's motion and swipes, either alone or in combination with touch sensitive surface, to control the device and remotely controllable devices. The present invention is particularly, but not exclusively, useful as a wearable device that is custom programmable to control other devices such as a television, a cable box, a home automation system, and a heads-up display. The present invention is also useful as a wearable device capable of executing a locally stored application or local commands.

### BACKGROUND OF THE INVENTION

The present invention relates to a controller for computers and other devices capable of receiving commands from a remote device, and more particularly, to a wearable touch and motion sensitive device capable of sending commands to other devices through a wireless connection.

Devices for sensing a user's input are widely used in modern day life. For example, touchpads are capable of sensing the touch of a single finger as it moves across the face of the touchpad to perform a specific function. However, many of the touchpads today are capable of sensing multiple fingers touching the screen simultaneously as they move on the screen to perform different functions. Two fingers sliding from left to right on the touchpad may shift focus to a different window while two fingers sliding from bottom to top may close the current window. In a home automation environment, two fingers moving left to right may turn on one set of lights, and moving two fingers from right to left may turn off the same lights. The touchpad is typically used as an input device only but some touchpads offer additional capabilities, as discussed below.

U.S. Pat. No. 8,402,372, issued to Gillespie et al, discloses a touch screen device having a display coupled to a computer. The screen displays a plurality of icons with at least one of the icons identifying at least one region on the screen that, when touched, will cause an action on the computer without changing what is displayed on the screen.

US Patent Application No. 2007/0211038, issued to Tsai et al, discloses a multifunction touchpad placed on an operation panel of a notebook computer, comprising a display panel, a control module, and a wireless transmission module. The touchpad can display an operation menu and a system message on the display panel by way of a software program, and can be used wirelessly when separated from the notebook computer. This device detects whether the “mode switch” has been pressed and if so, switching to a corresponding operation mode.

US Patent Application No. 2012/0075193, issued to Marsden et al, discloses a method and system that integrates a numeric keypad with a touchpad in the same physical location on a touch-sensitive display device. Operational mode of the same location is automatically determined based on user actions with the display or based on a manual entry by the user. The system operates in at least one mode of operation selected from: numpad mode, touchpad mode, keyboard mode and auto-detect mode. A visual indicator communicates with the user which mode is the current mode.

Finally, U.S. Pat. No. 6,970,157, issued to Siddeeq, discloses a wearable computing, input, and display device. In a preferred embodiment, the device is secured to the user's wrist by a band. A small and foldable keyboard conforms to the outside of the wrist strap and, when unfolded, can be extended such that the user may manipulate the keys on the keyboard with the same hand that the device is mounted on. The display does not have a touch capability nor is it responsive to gestures by detecting the motion of the wearer's hand.

All of the above referenced patents and patent applications disclose the basics of a user interface device in that they allow for basic inputs to be translated to an action on a remote device. However, modern technology has become small and advanced enough that traditional methods of interacting with remote devices limit the ability of a user to efficiently control the remote devices. As more controllable devices are integrated into a user's environment, the complexity of a user interface will increase and may require the user to navigate through multiple screens to reach the desired setting. Further, since the number and type of devices and systems capable of being monitored or controlled through a remote device have greatly increased in the recent past, current devices lack efficient and intuitive interfaces having extended ways to input commands into the device needed to control multiple remote devices. Also, many of the current touchscreen based programmable remote control devices lack the ability to be custom programmed to simplify the control of the various remote control devices. The wearable devices also lack the ability to detect motion that can be translated into a command for controlling a remote device. Lastly, current touchscreen based programmable remote control devices are not wearable on a users person thereby limiting the ability of a user to efficiently and quickly adjust a remote device.

Therefore, it is desirable to provide a new programmable multi-touch device and control method incorporating wireless capability and motion detection, capable of controlling multiple remote devices, and wearable by a user to solve the shortcomings mentioned above. It is also desirable to provide a new programmable multi-touch device that can interface with remote devices through a variety of communication networks.

### SUMMARY OF THE INVENTION

Disclosed is a wearable device having a display and a touch sensitive display or pad such as a touchscreen interface. The device is sensitive to single touches and swipes. The device also has a multi-touch capability where two or more fingers are used to touch and swipe. The multi-touch capability can sense when multiple fingers are used to swipe in unison as well as sense when one finger remains stationary when touching the device while another finger swipes across the device. The device also contains motion sensors to detect motion in three (3) axes. The device is capable of mapping swipes, touches, gestures, or combinations of swipes, touches, and gestures to specific commands, which are then transmitted to a remote controllable device or is used locally by the wearable device.

In alternative embodiments, the wearable device further consists of a microphone or a speaker and microphone. The user may then use spoken commands in conjunction with swipes, touches, and gestures for specific commands or may use spoken commands to replace swipes, touches, and gestures.

The wearable device may also connect to a cloud, Internet, or cellular network to allow communication with a remote network containing remote controllable devices, such as lighting and HVAC systems.

In certain embodiments of the present invention, proprioceptive science is involved in the invention's operation. Proprioception is the ability to sense stimuli arising within the body regarding position, motion, and equilibrium. A blindfolded person knows through proprioception if an arm is above the head or hanging by the side of the body. In humans, proprioception is provided by proprioceptors in muscles, tendons, and joints. The human brain integrates proprioceptive information with information from the vestibular system to create an overall sense of body position, movement, and acceleration. Due to the variations in the contemplated shapes and sizes of the present invention, coupled with the “feel” associated with each shape and size as sensed using proprioceptive principles, swipes and gestures may slightly vary. The present invention takes into account these variations to generate consistent commands.

Other objects, advantages, and novel features of the invention will become more apparent from the following detailed description when taken in conjunction with the accompanying figures.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a top view of a prior art device having icons linked to various functions found on a modern computer;

FIG. 2 is a top view of the prior art device in FIG. 1 showing an alternative screen having icons to control common commands used in a modern computer;

FIG. 3 is a perspective view of a prior art device showing a detachable control pad having an integrated display capable of acting as a touch pad while displaying system messages;

FIG. 4 is a side view of a prior art device that is wearable. The device has an integrated keyboard to allow the user to interface with the device;

FIG. 5 is a perspective view of the device of FIG. 4 showing the integrated keyboard connected to a display component through articulated linkage between the keyboard and the wrist strap;

FIG. 6 is a perspective view of a preferred embodiment of the present invention showing the device having a touch screen and a display;

FIG. 7A is a top view of a preferred embodiment having a round face showing the touchable area of the touchscreen divided into quadrants and clock numbers disposed around the outside edge of the display;

FIG. 7B is a top view of an alternative embodiment having a square face showing the touchable area divided into quadrants and clock numbers disposed around the outside edge of the display;

FIG. 8A is a top view of a preferred embodiment showing a reference finger touching the “six o'clock” area of the display and showing a command finger touch location sweeping along the clock numbers;

FIG. 8B is a top view of a preferred embodiment showing a reference finger covering clock number 6 and two touch locations for command fingers starting at a location central to the display and sliding up to the clock numbers located at the top of the display;

FIG. 8C is a top view of a preferred embodiment showing a reference finger covering the “six o'clock” position and the touch locations for two command fingers that are slid in a counter-clockwise along the outside edge of the display;

FIG. 8D is a top view of a preferred embodiment showing a reference finger showing a reference finger placed on the display and two command finger touch locations that are slid down from the top of the display to near the middle of the display;

FIG. 9A is a top view of a preferred embodiment showing a reference finger placed over the “12 o'clock” position and a command finger touch location starting at the “6 o'clock” position and slid counter-clockwise along the outer edge of the display to the “3 o'clock” position;

FIG. 9B is a top view of a preferred embodiment showing a reference finger placed over the “10 and 11 o'clock” position and a command finger touch location starting at the “2 o'clock” position then slid either toward or away from the center of the display to enter the number “2” into the device;

FIG. 9C is a top view of a preferred embodiment showing a reference finger touch location at the center of the display and a command finger touch location on the “2” then slid either toward or away from the center of the display to set the time of the device to either 2 a.m. or 2 p.m.

FIG. 10 is a top view of a preferred embodiment showing a reference finger placed over the “6 o'clock” position and the different messages that can be sent by placing a command finger along the outer edge of the display and swiped in either the clockwise or counter-clockwise direction;

FIG. 11A is a top view of a preferred embodiment showing a reference finger placed along the outer edge of the display and a command finger touch location that is slid either clockwise or counter-clockwise to adjust the current temperature setting of an HVAC system;

FIG. 11B is a top view of an alternative embodiment having a display showing HVAC information and controls;

FIG. 11C is a top view of a preferred embodiment having a display showing a combination lock style interface;

FIG. 11D is a top view of a preferred embodiment having a display showing the inputting of a second number in the combination for the combination lock style interface;

FIGS. 12A-D are top views of an alternative embodiment showing one (1), two (2), or three (3) locations starting at a first position then slid to a second position;

FIG. 13 is a side view of a preferred embodiment of the present invention being worn on a user's wrist showing the directions the user may move or gesture with the invention, which are mapped to a control command or data request;

FIG. 14 is a schematic view of a preferred embodiment of the present invention wirelessly connected directly (i.e. via Bluetooth, WiFi, or Near Field Communication (NFC)) to a remote controllable device such as a tablet computer or a head mounted audio and video system;

FIG. 15 is a schematic view of a preferred embodiment of the present invention wirelessly connected to a remote controllable system through a wireless connection;

FIG. 16 is a schematic view of an alternative embodiment connected wirelessly to a remote wireless interface device, which in turn is connected to a local network having remote controllable devices connected thereto; and

FIG. 17 is a schematic view of an alternative embodiment of the present invention showing the wireless device connected to a communication cloud, such as the Internet or a cellular network.

### DETAILED DESCRIPTION

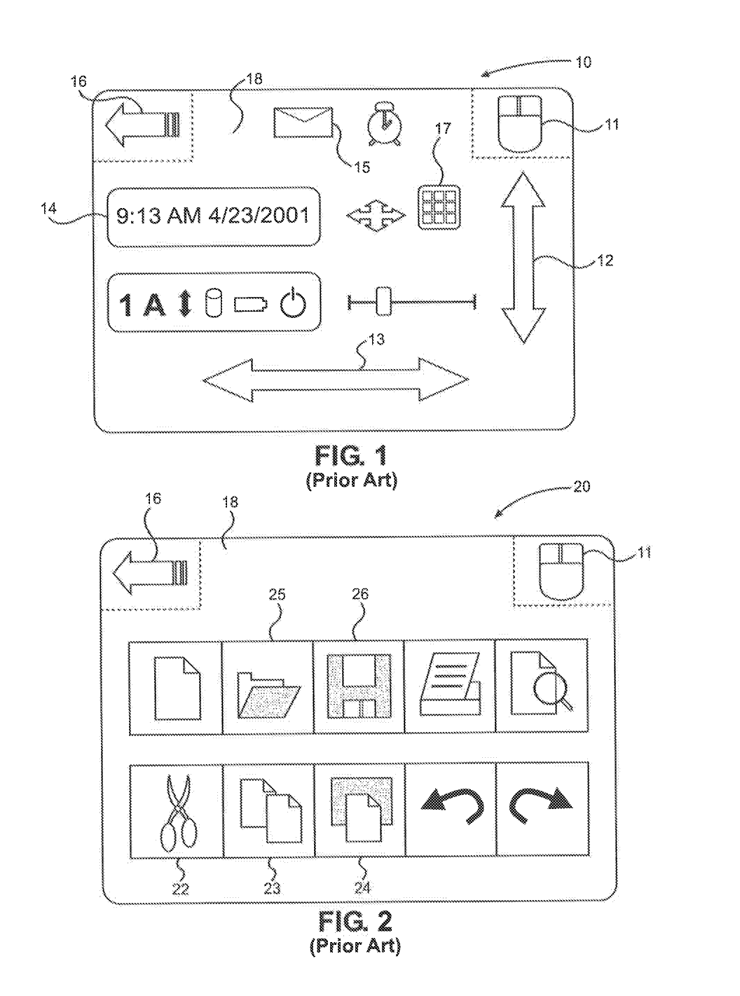

Referring initially to FIG. 1, a top view of a prior art device is shown and designated 10. Device 10 consists of a screen 18 that displays multiple icons used to control a program running on a remote computer. For example, the icons displayed are mouse right click 11, vertical scroll 12, horizontal scroll 13, time and date 14, mail 15, “back” function 16, and calculator 17. Device 10 can be used as a touchscreen to tap a desired icon or the screen can be configured to act as a touchpad to control the cursor on a computer. Device 10 is limited to only displaying only system-like icons that are used with a typical computer. Device 10 does not have the capability to recognize gestures and is not wearable but rather it is integrated into a computer.

FIG. 2 is a top view of another group of icons on screen 18 of device 10. The icons displayed are common to modern computer applications. The icons displayed are cut 22, copy 23, paste 24, open file 25, and save 26.

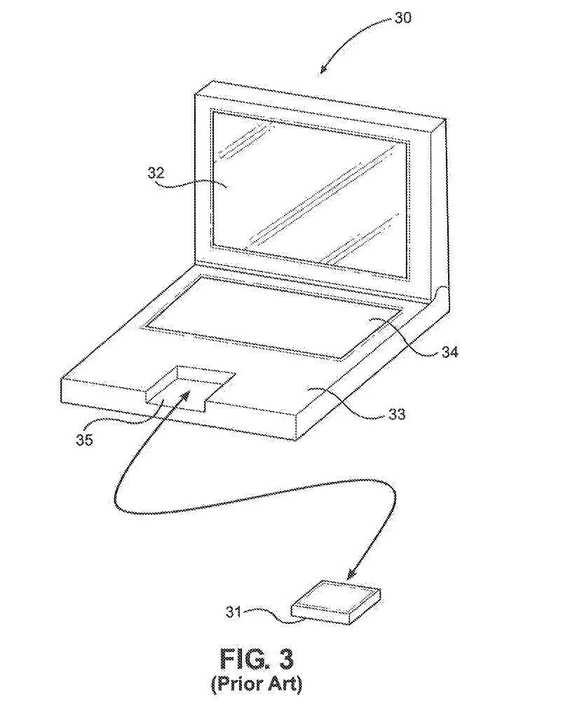

FIG. 3 is a top view of another prior art device and designate 30. Device 30 consists of a laptop 33 having a screen 32, keyboard 34, and removable display device 31. Display device 31 communicates wirelessly with laptop 33. Display device can display system messages as well as custom icons. However, this device cannot interpret gestures or motion and translate them into a command function.

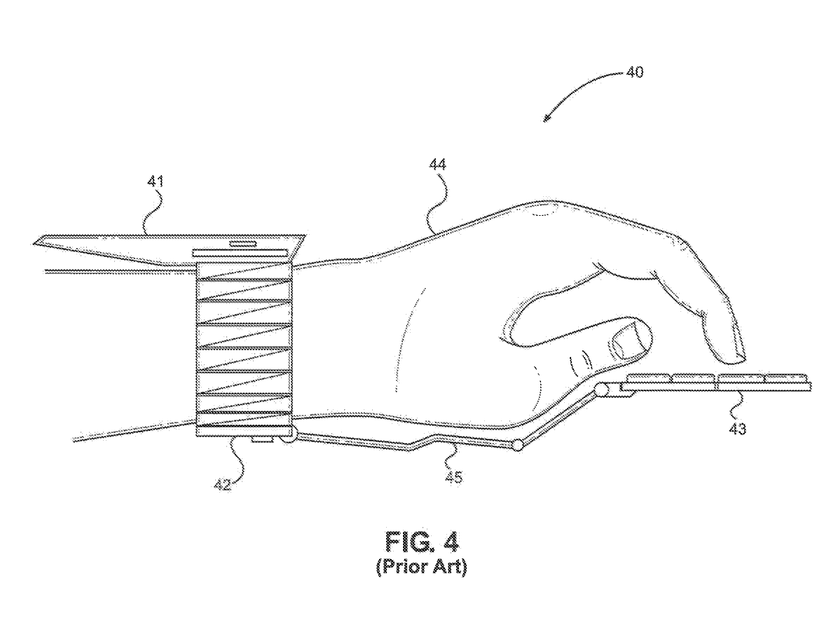

FIG. 4 is another prior art device and designated 40. Device 40 consists of a computing mechanism 41, a wrist strap 42, and a keyboard 43 connected to wristband 42 through linkage 45. Device 40 is shown being worn by a user 44 with the keyboard 43 fully extended such that the user 44 can manipulate the keyboard 43. When the user is finished using the keyboard 43, it can be retracted such that the keyboard 43 conforms to the outside to wrist strap 42. Device 40 cannot sense motion or gestures nor does it allow the user to program custom touches and swipes.

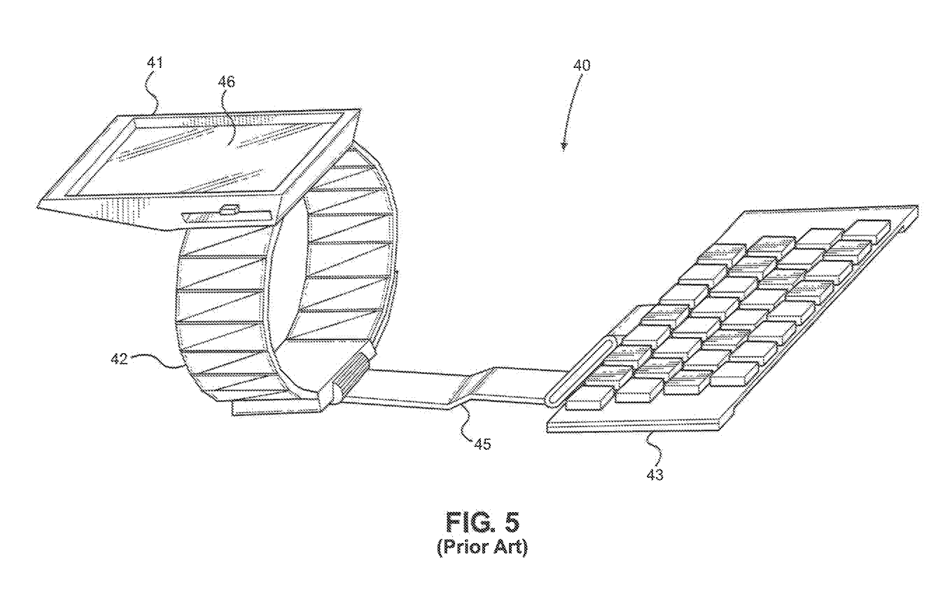

FIG. 5 is a perspective view of device 40 showing screen 46 on computing mechanism 41. Screen 46 can display the results of the computing by device 40 and is configured to interface with other peripheral devices such as a heads-up display (not shown).

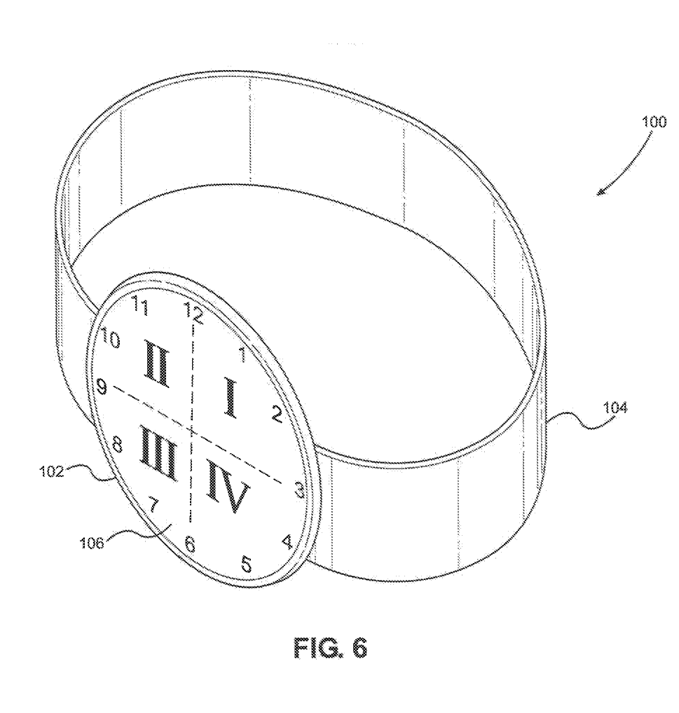

FIG. 6 is a perspective view of a preferred embodiment User Programmable Touch and Motion Controller of the present invention and designated 100. Controller 100 consists of a body 101 and a central processor 102 having a touchscreen display 106, which is connected to wrist strap 104. Screen 106 is shown with designated quadrants I through IV to aid a user in creating custom swipes and touches. It is to be appreciated by someone skilled in the art that screen 106 may have no permanent markings such that processor 102 in conjunction with the display capabilities of screen 106 generates all images displayed, such as time numbers and function buttons.

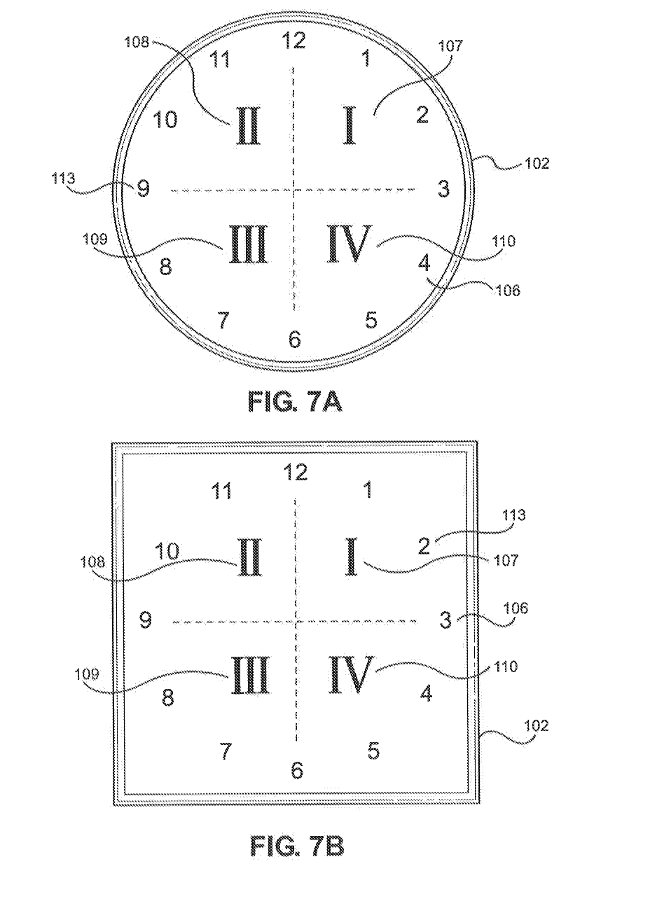

FIG. 7A is a top view of screen 106 with designated quadrants I through IV. Shown is quadrant I 107, quadrant II 108, quadrant III 109, and quadrant IV 110. It is to be appreciated by one skilled in the art that the quadrant designations are for programming and explanation purposes and embodiments involving more than four (4) sections are fully contemplated. In operation, a user can interact with the screen 106 starting in any quadrant. For example, the user may program the device 100 such that a swipe starting in quadrant I 107 and moving down into quadrant IV 110 may performs a particular function while a similar motion that starts in quadrant II 108 and moves down into quadrant III 109 may perform a different function. As a further example, the first swipe from quadrant I 107 to quadrant IV 110 may turn off a remote controlled light while the swipe from quadrant II 108 to quadrant III 109 may cause display 106 to show a new screen providing access to additional functions, such as an interface to a remote controlled air conditioning system.

FIG. 7B is a top view of screen 106 with designated quadrants 107 through 110, where the display 106 is a square face. The functionality of the device does not differ based on the shape of display 106.

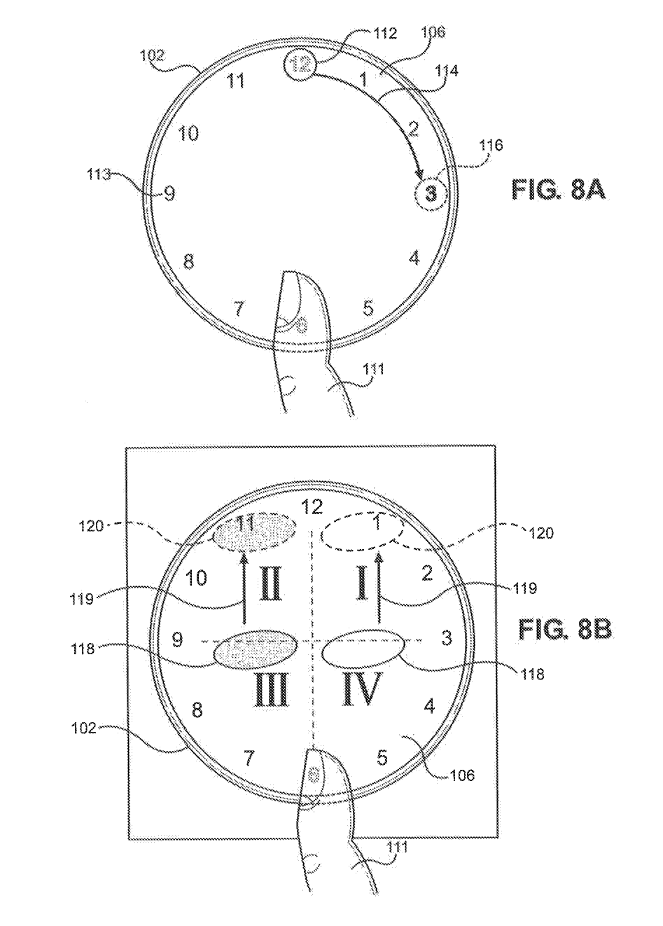

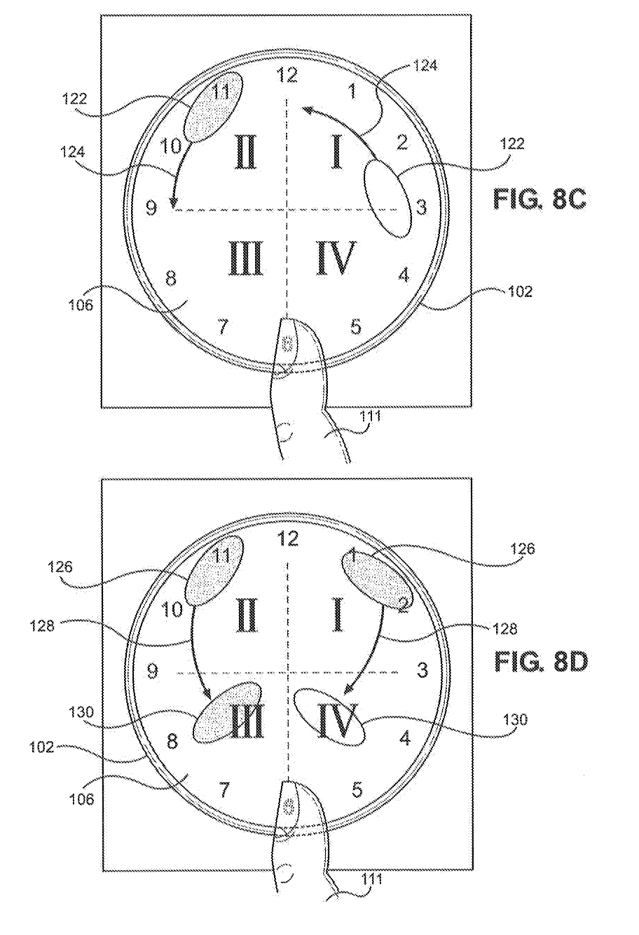

FIG. 8A is a top view of a preferred embodiment showing a multi-touch interaction between a user and the device 102. Shown is reference finger 111 placed on the ‘6’ of the clock numbers 113. A command finger is then placed on starting position 112 located at the outer edge of display 106 on the “12 o'clock” position and slid along the outer edge of display 106 in clockwise direction 114 to final position 116 located at the “3 o'clock” position. The placement of reference finger 111 initiates a particular function while a command finger is placed at a given position and slid to a final position thereby inputting a command into device 102. It is to be appreciated by one skilled in the art the any finger, or combination of fingers, can be used to provide the reference input while any fingers not used to provide the reference input can be used individually or in combination to provide the command input. The commands initiated by placing a reference finger at a particular position and sliding one or more command fingers from a starting position to a final position can be pre-programmed through the use of a specific device or software or can be custom programmed to suit a user's needs. For example, device 102 may be programmed such that the placement of the reference finger 111 and the swipe of the command finger in direction 114 may increase the brightness of a screen, or raise the volume of a remote device. If the command finger starts at position 116 and is slid in the direction opposite to direction 114 to position 112, device 102 may decrease brightness of a screen or lower the volume of a remote device. It is to be appreciated by one skilled in the art that reference finger 111 may be place at most any location on display 106 and one or more command fingers positioned on display 106 then slid to a final position to invoke actions on device 102 or a remote device.

FIG. 8B is a top view of a preferred embodiment showing reference finger 111 placed on display 106 and two (2) command fingers placed at starting positions 118 then slid in direction 119 to final positions 120. For example, this combination of reference finger 111 location and command fingers starting and ending locations may be used to control a car in a car racing game being played on a remote device. The movement of command fingers in direction 119 may cause a player's car to accelerate. Movement of command fingers in the direction opposite direction 119 may cause the car to decelerate while holding the command fingers stationary in the center of display 106 may cause the car to brake. In alternative embodiments, touches to screen 106 may be used in conjunction with movement of device 102, such as pitch, roll, and yaw, to control device 102 or a remotely controlled device.

FIG. 8C is tip view of a preferred embodiment showing reference finger 111 placed on display 106 and command fingers placed on starting positions 122 and slid in direction 124 along the outer edge of display 106. For example, this combination of touches and slides may be used to steer a car in a car racing game to turn left. If command fingers are slid in the direction opposite direction 124, the car will turn right. The distance a user slides the command fingers can determine the turn radius of the car.

FIG. 8D is a top view of a preferred embodiment showing another combination of reference finger 11 and command finger swipes. Reference finger 111 is positioned on display 106 and command fingers are placed at starting positions 126 then slid in direction 128 to final positions 130. For example, this touch and swipe combination may be used to control a slingshot based game such as Angry Birds™. When command fingers are slid in direction 128, the sling is pulled back. The farther command fingers are slid in direction 128, the farther the sling is pulled back. When the command fingers are lifted from display 106, the slingshot is fired. The user may then input further commands as needed to play the game, such as tapping screen 106 to activate a game feature like initiating a burst of speed or dropping a payload.

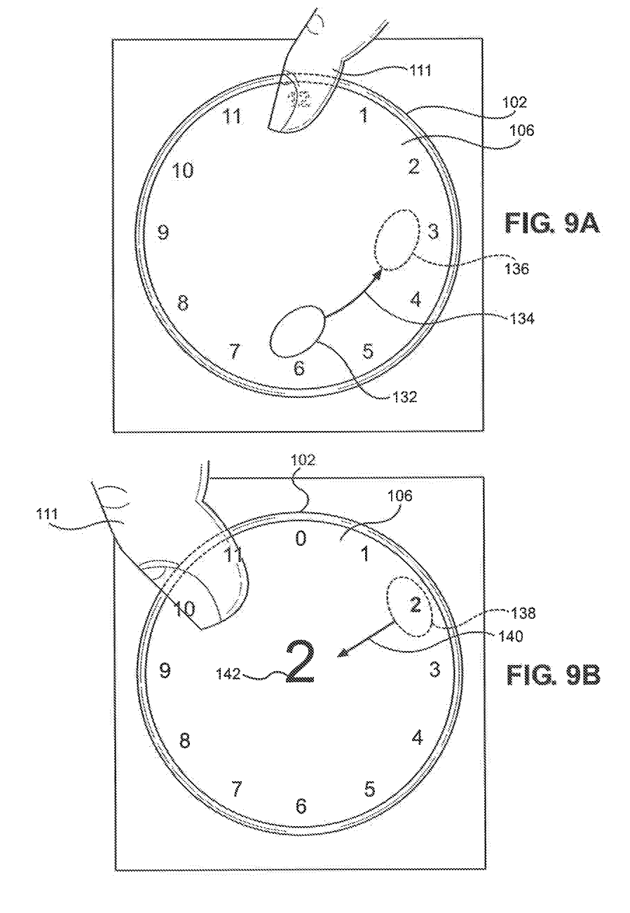

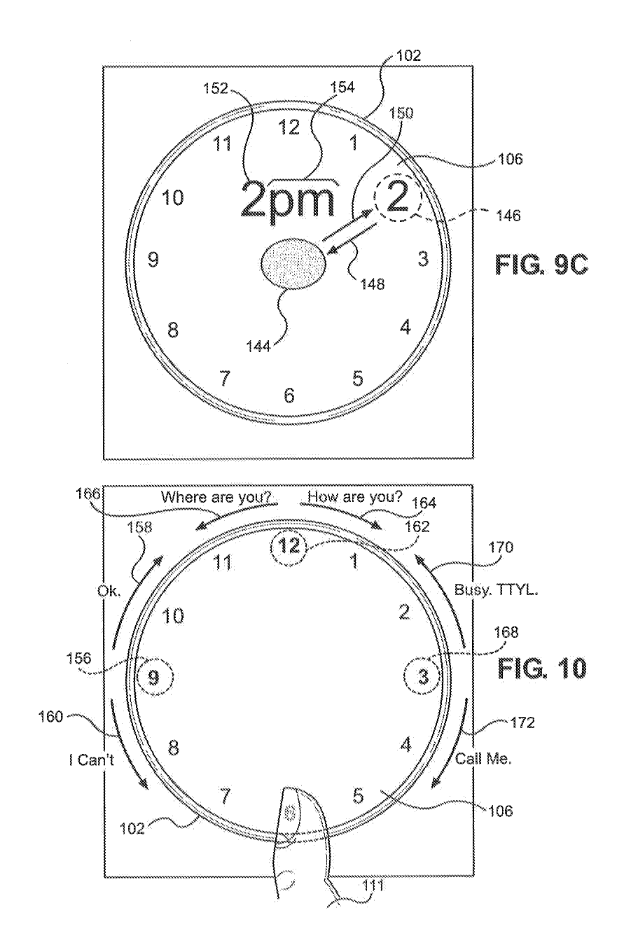

FIG. 9A is a top view of a preferred embodiment showing a reference finger placed 111 at the “12 o'clock” position near the outer edge of display 106. A command finger is then placed at starting position 132 and slid in direction 134 to final position 136. In this preferred embodiment, the index finger is used as reference finger 111 and the thumb is used as the command finger. It is to be appreciated by one skilled in the art that starting position 132 may be at any location on display 106 and moved in any direction for any distance on display 106 to generate the desired response in the local device 102 or a remote device.

FIG. 9B is a top view of a preferred embodiment showing a reference finger 111 place approximately over the “11 o'clock” position on display 106 and a command finger placed at the “2 o'clock” starting position 138 then slid in direction 140. For example, the touch and swipe combination may be used to set the input number 142 to ‘2’. In the preferred embodiment, if the command finger is slid in the direction opposite to direction 140, then input number 142 is erased.

FIG. 9C is a top view of a preferred embodiment showing a reference location 144 and a command location 146 at the “2 o'clock” position of display 106. The finger touching command location 146 is then slid in either direction 148. For example, this touch and swipe combination may be used to set the time on device 102. The command finger being placed at starting position 144 sets the time number 152 to the number ‘2’ while the movement in direction 148 sets the meridiem 154 to “a.m.” or movement in direction 150 sets the meridiem 154 to “p.m.”

FIG. 10 is a top view of a preferred embodiment showing reference finger 111 placed at the “6 o'clock” position. Also shown are possible reply messages that are determined by where the command finger is placed and moved. For example, if the user places the command finger at starting location 156 and slides the finger in direction 158, the message “OK” is sent. If the command finger is instead slid in direction 160, the message “I can't” is sent. Other messages shown are “Where are you?”, “How are you?”, “Busy. TTYL”, and “Call me.” It is to be appreciated by one skilled in the art that the messages sent are fully customizable to meet the needs and desires of a user. It is also to be appreciated that the available messages on any particular screen are determined by the placement of the reference finger 111 and that the number of messages available per reference touch location are only limited by the number of usable touch locations available on display 106. It is to also be appreciated by someone skilled in the art that pre-programmed or custom messages may be displayed on display 106 to aid a user in selecting the proper response message.

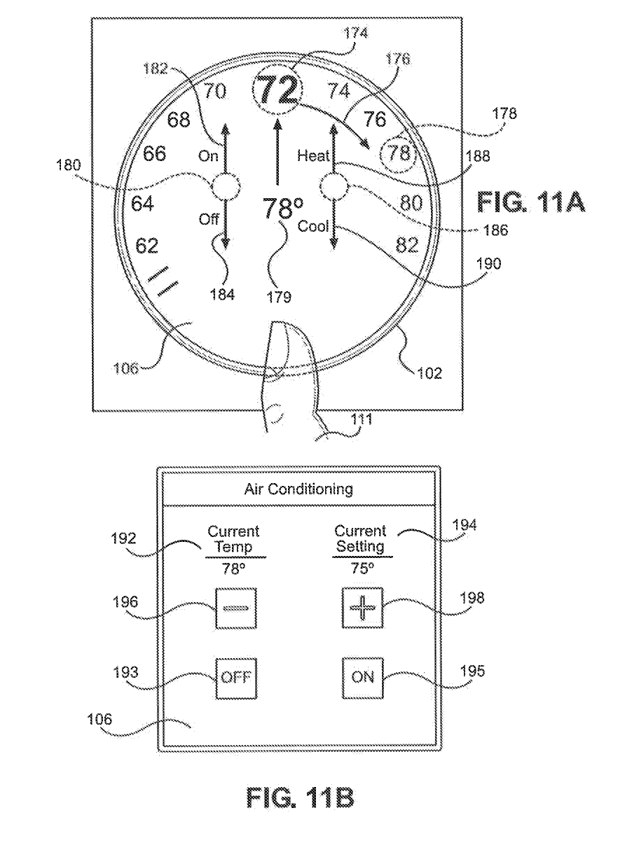

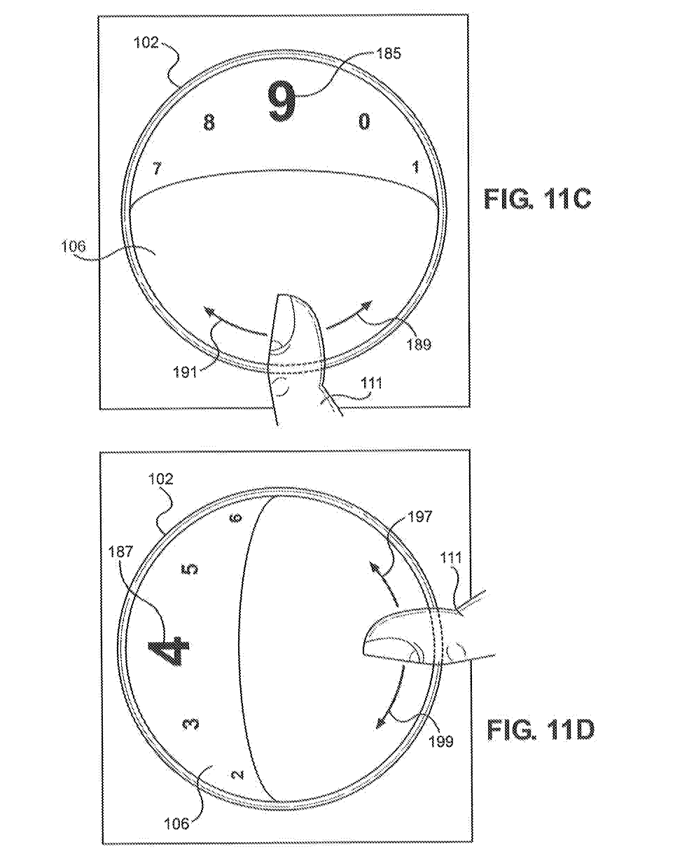

FIG. 11A is a top view of a preferred embodiment showing an exemplary HVAC interface. Reference finger 111 is placed at what would be the “6 o'clock” position of display 106. A command finger then is placed at starting position 174 and moved in direction 176 to final position 178. The temperature displayed at starting position 174 can be the current temperature or the current set point of the HVAC system. Shown at starting position 174 is the current set point of the HVAC system set to 72 degrees, Final position 178 is on the “78” indicator meaning that the new temperature set point for the HVAC system is seventy-eight (78) degrees. If the command finger is moved in a direction opposite direction 176, then the new set point will be lower than the current set point. It is to be appreciated by one skilled in the art that the final position will determine the set point for the HVAC system. Device 102 may also be configured to allow a user to turn on or off the HVAC system by touching the command finger to starting position 180 then sliding the command finger in either direction 182 or 184 to turn the HVAC system on or off respectively. Further, device 102 may also allow a user to set the HVAC system to “Heat” or “Cool” by placing the command finger at starting location 186 them sliding the command finger in either directions 188 or 190 to set the HVAC system to either “Heat” or “Cool”, respectively. Device 102 may also be configured such that the new temperature set point is shown at starting location 174 after the new temperature set point has been input into device 102.

FIG. 11B is a top view of an alternative embodiment of the present invention where screen 106 shows an alternate HVAC control screen having remote system information and buttons to control the system. Shown is current temperature 192, current setting 194, button 196 for lowering current setting 194, button 198 for raising current setting 194, and buttons 193 and 195 for turning the air conditioning system on and off respectively. Screen 106 may also be configured to display a control to select between “heat” and “cool” functions. It is to be appreciated by one skilled in the art that this control screen is merely representative of an exemplary function and does not limit the types of systems that can be controlled by device 102 or how remote system information is displayed on screen 106.

FIG. 11C is a top view of a preferred embodiment of the present invention where display 106 shows a combination style lock interface for use with a remote system having increased security requirements or to avoid accidental tampering or adjustment to the remote system. In an exemplary operation, a reference finger 111 is placed at the “6 O'clock” position on display 106 and a corresponding lock combination number 185 appears opposite to reference finger 111. Reference finger 111 is stationary while command finger at position 185 moves in direction 189 or 191 causing lock combination number 185 to change to a desired digit. A user may hold reference finger 111 at the position for the desired number for a predetermined amount of time to set the number. Alternatively, the user may tap display 106 to set the desired number. After the first number 185 is set, reference finger 111 is stationary while command finger at position 187 moves in direction 189 or 191 to set the second number 187 (see FIG. 11D). A user repeats this process until all necessary numbers have been entered into device 102 thereby unlocking the remote system to allow device 102 to interface with it. As an additional level of security, the location of reference finger 111 may also be used to determine the proper combination for a system or device. For instance, reference finger 111 at the “6 o'clock” position followed by the input of the numbers “6”, “8”, and “1” is a different combination when reference finger 111 is placed at the “5 o'clock” position followed by the input of numbers “6”, “8”, and “1”. It is also to be appreciated by one skilled in the art that letters, numbers, and symbols may be used in a combination. To set the number, the user may then hold the fingers in position for a predetermined amount of time or tap display 106 with one or both fingers to set the desired number. It is also to be appreciated by someone skilled in the art that multiple reference fingers may be used to determine the proper combination.

FIG. 11D is a top view of a preferred embodiment of the present invention where display 106 shows the input of second number 187. To set a third and subsequent numbers, reference finger 111 may be slid in directions 197 and 199 to set the desired number.

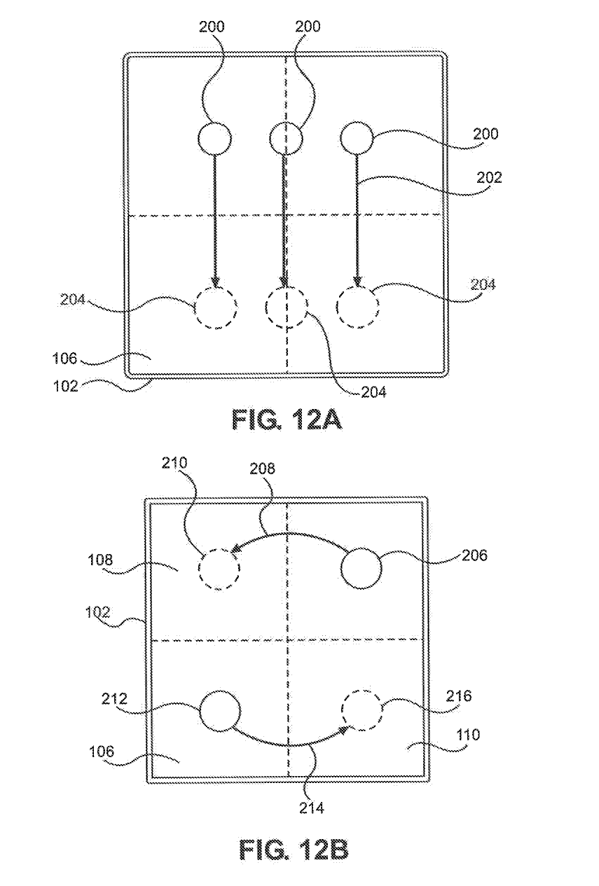

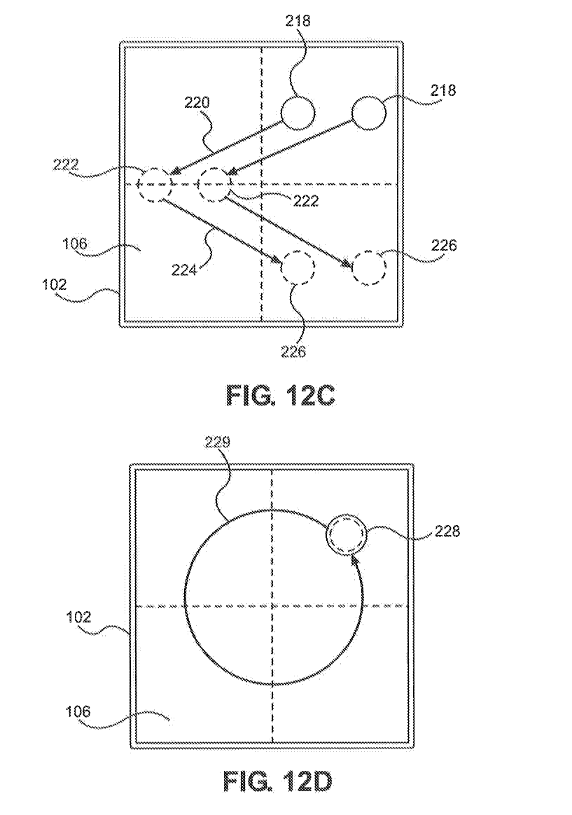

FIG. 12A is a top view of an alternative input method. As shown, a user can place three (3) fingers on the screen spanning quadrant I 1107 and quadrant II 108 at starting position 200. The user then slides their fingers in direction 202, while maintaining contact with screen 106, until the user's fingers reach final position 204, where the user's fingers are then lifted off screen 106. As described above, the user may map this swipe to a specific function on either the device 102 or a remote controlled system.

FIG. 12B is a top view of an alternative input method for device 102. As shown, a user touches a first finger to initial position 206 and a second finger to a second initial position 212. The user then moves the first finger in direction 208 and the second finger in direction 214 such that the first finger stops at final position 210 in quadrant II 108 and the second finger stops at final position 216 in quadrant IV 110. It is to be appreciated by one skilled in the art that this swipe motion may also start in quadrant II 108 and quadrant IV 110 and may also move in a clockwise direction.

FIG. 12C is a top view of an alternative input method for device 102. As shown, two (2) fingers are placed on starting positions 218 then moved in direction 220 to intermediate positions 222, then moved in direction 224 to final positions 226. It is to be appreciated by one skilled in the art that this swipe motion may be accomplished using one (1) finger or multiple fingers simultaneously. It is to be further appreciated by someone skilled in the art that a swipe sequence may consist of multiple fingers and multiple intermediate positions similar to intermediate position 222. It is also to be appreciated by someone skilled in the art that a first finger may be moved to an intermediate position, a second finger then moved to an intermediate position, the first finger then moved to a final position, then the second finger moved to a final position to initiate a specific function or action.

FIG. 12D is a top view of yet another alternative input method for device 102. As shown, a user touches position 228 with a command finger then moves it in a counter-clockwise direction 229 until the command finger returns to position 228. It is to be appreciated by one skilled in the art that this swipe motion may be performed using multiple fingers and may start at any location on the touch screen. It is to be further appreciated by someone skilled in the art that the swipe sequence may stop at an intermediate location along direction 229 to activate a specific function or action.

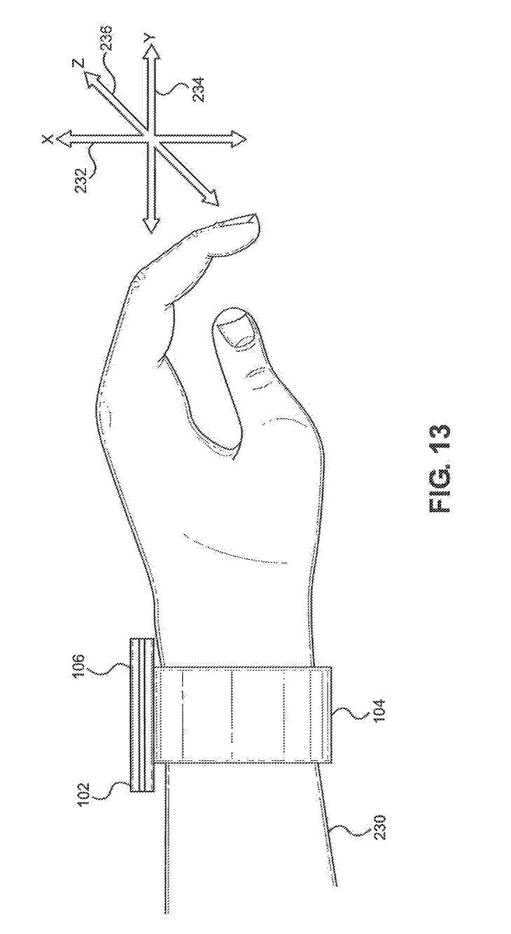

FIG. 13 is a side view of an alternative embodiment of the present invention worn on a user's arm 230. Device 106 is attached to wrist strap 104 and is worn around the wrist of the user's arm 230. It is to be appreciated by one skilled in the art that device may be attached to a user in various ways without departing from the spirit of the invention. For example, device 102 may be attached to a user's chest area, worn around a user's neck using a lanyard, or attached to a user's waist using a clip or belt. Device 106 consists of motion sensing sensors that allow the device to detect motion in three (3) axes, specifically the X axis 232, the Y axis 234, and the Z axis 236, including acceleration. Detected motion is translated by device 106 into a command programmed into the device 106 for execution on device 106 or a remotely controlled device. For example, waving the user's arm 230 from left to right along the Z axis 236 may be mapped to a function that causes a remote controlled system to turn off. Conversely, waving user's arm 230 from right to left along Z axis 236 may cause the same remote system to turn on. The interpretation of movements may be determined, in whole or in part, by the location of a reference finger (not shown), alone or in conjunction with command finger(s), placed on screen 106. It is to be appreciated by one skilled in the art that numerous hand motions may be mapped to a function and is only limited by the sensitivity of the motion sensors. It is also to be appreciated by one skilled in the art that hand motions may be used in conjunction with swipes or button presses on screen 106.

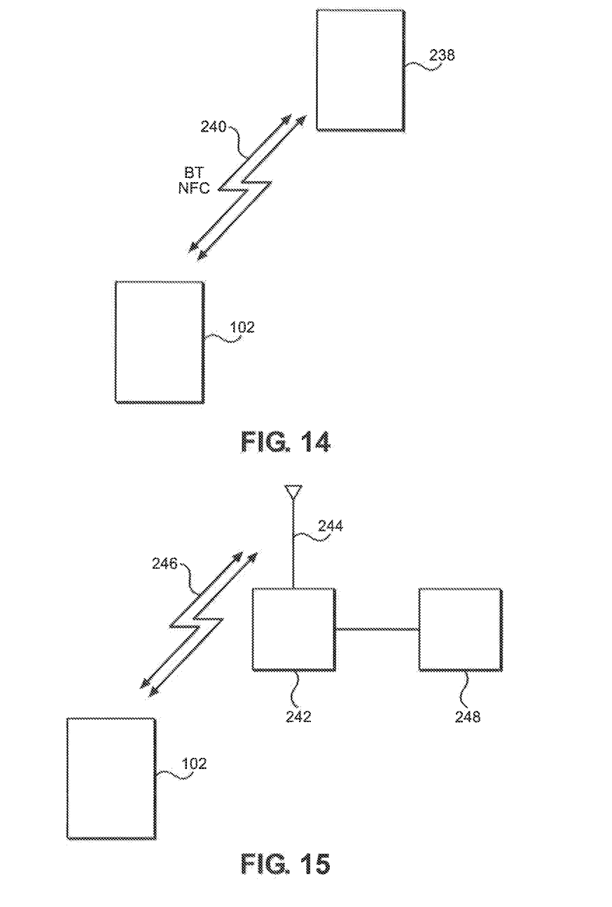

Referring to FIG. 14, a schematic view of a preferred embodiment connected directly to a remote wireless device. Device 102 is wirelessly connected to remote device 238 by way of radio frequency energy 240. A user then may use device 102 to input commands to remote device 204 and to receive remote device data for display on device 102. For example, device 102 may use Bluetooth™ or near field communication (NFC) to communicate with remote device 204. It is to be appreciated by someone skilled in the art that the method of wireless connection (e.g. Bluetooth or NFC) may also affect the interpretation of user input. For example, since NFC is designed to function only when two NFC enabled devices touch or almost touch each other, a swipe sequence transmitted over a NFC data link may be interpreted to perform one particular function, either locally or on the NFC connected device, where the same swipe sequence over a Bluetooth connection may be interpreted to perform a different function. For example, NFC may be used to set an access code for a remote device where the local device then uses a Bluetooth or other wireless connection to send and receive system control functions and other data.

Referring now to FIG. 15, a schematic view of a preferred embodiment connected to a remote wireless interface device is shown. Device 102 is wirelessly connected to remote wireless interface device 242 by way of radio frequency energy 246 received by antenna 244. Remote device 248 is connected to wireless interface device 242 to allow device 102 to receive status information from remote device 248 or to send control commands to remote device 248.

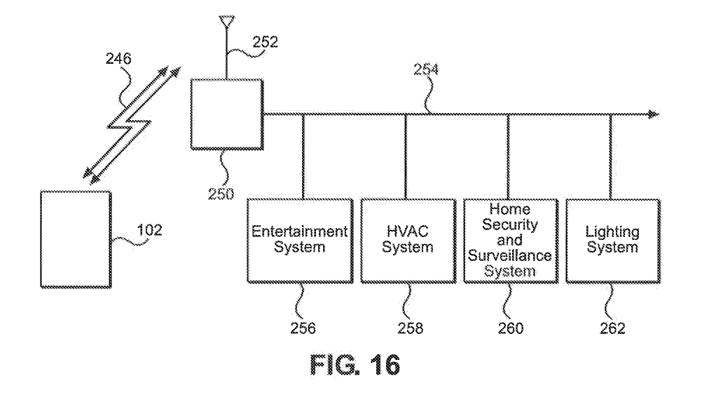

FIG. 16 is a schematic view of an alternative embodiment of the present invention connected to wireless access device 250 through antenna 252 by way of radio frequency energy 246. Local network 254 connects wireless access device 250 to network addressable devices. For example, local network 254 may be connected to an entertainment system 256, an HVAC system 258, home security and surveillance system 260, and lighting system 262. Device 102 has the ability to communicate with each network addressable device such that device 102 exchanges information with the network addressable devices and can send control commands to each individual device to control its local operations. As a non-limiting example, device 102 may receive temperature information from HVAC system 258, such as current temperature, current setting, and system mode then send control commands to HVAC system 258 to switch the system cooling mode and adjust the current setting to the desired temperature.

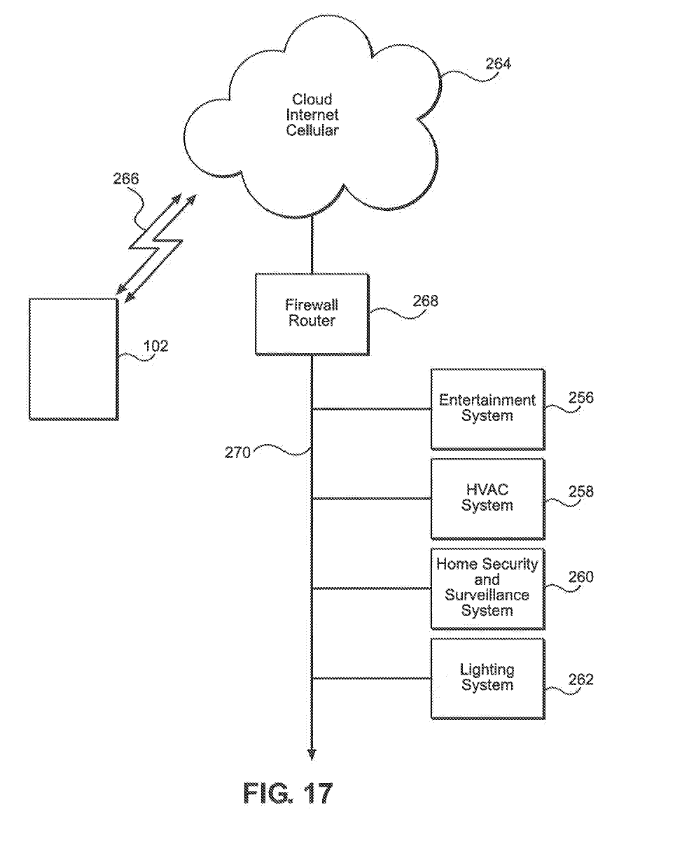

Referring to FIG. 17, a schematic view of an alternative embodiment is shown. Device 102 is connected to cloud 264 by way of radio frequency energy 266. It is to be appreciated by one skilled in the art that device 102 may connect to a cloud network, the Internet, Wi-Fi, or a cellular network and still perform the same command and control functions described below. Also connected to cloud 264 is a firewall/router 268, which then connects to local network 270. Connected to local network 270 are one or more network addressable devices. For example, as described in conjunction with FIG. 16, entertainment system 256, HVAC system 258, home security and surveillance system 260, and lighting system 262 are connected to firewall/router 268 through local network 270. In operation, a user of device 102 may input commands through a combination of swipes and touches to either receive system information or to send a control function to the remote system. Device 102 contains the required interface and communication protocols to establish the connection between device 102 and cloud 264 as well as between device 102 and firewall/router 268, and between device 102 and the network addressable devices. It is to be appreciated by someone skilled in the art that device 102 may work in conjunction with another device (not shown), such as a smartphone or tablet, to perform a desired function.

In other alternative embodiments, device 102 further consists of a microphone and the ability to translate spoken commands into digital commands. Spoken commands may be used individually or may be used in conjunction with swipes, touches, and gestures to send the desired control command, thereby enhancing the efficiency and ease of use of device 102. Device 102 may also have a speaker and a vibration function to alert the user that a system is in need of monitoring and control. Users may also be alerted by one or more indications such as a blinking or steady light, screen 106 flashing or staying on, and sound, as well as vibration. Device 102 may also have an integrated short range wireless technology, such as Bluetooth, to allow the user to hear the alerts through a wireless speaker or hear and send commands through a hands free device.

While there have been shown what are presently considered to be preferred embodiments of the present invention, it will be apparent to those skilled in the art that various changes and modifications can be made herein without departing from the scope and spirit of the invention.

We claim:

1. A user programmable touch and motion controller, comprising:
a body;
a central processor disposed within the body; and
a touch sensitive display or pad in communication with the central processor and configured to display images and generate a signal in response to one or more touches and swipes,
wherein the controller executes a function in response to the one or more touches or swipes.

2. The controller of claim 1, wherein the touchscreen display is configured to respond to two or more simultaneous touches and swipes.

3. The controller of claim 2, wherein the two or more simultaneous touches and swipes consist of at least one reference touch point and at least one command touch point.

4. The controller of claim 3, wherein the at least one reference touch point initiates a specific command function.

4. controller of claim 4, wherein the touchscreen display is configured to display control specific images associated with the specific command function.

6. The controller of claim 3, wherein the at least one command touch point provides a data input to the specific command function.

7. The controller of claim 1, wherein the controller further comprises a wireless communication function.

8. The controller of claim 1, wherein the controller is configured to communicate with a remotely controllable device causing the remotely controllable device to execute a function in response to the communication.

9. The controller of claim 1, wherein the controller is configured to execute a function locally in response to the one or more touches and swipes.

10. The controller of claim 1, wherein the controller is further configured to provide an alert to the user using one or more of a light, vibration, and audio.

11. The controller of claim 1, the controller further comprising a means for sensing a motion pattern in three (3) perpendicular axes.

12. The controller of claim 11, wherein the motion pattern simulates the one or more touches or swipes to execute the function.

13. The controller of claim 11, wherein the controller is configured to activate the function based on the combination of the motion pattern with the one or more touches and swipes.

14. The controller of claim 1, wherein the controller is configurable to map a custom touch or swipe pattern to a specific function.

15. The controller of claim 1, wherein the controller is configured to recognize a swipe pattern consisting of one or more intermediate stopping points.

16. The controller of claim 1, wherein a swipe starting at a first position and moving to a second position invokes a first function and a swipe starting at the second position and moving to the first position invokes a second function different from the first function.

17. A method of operating a user programmable touch controller, the controller having a body, a processor, and a touchscreen display capable of sensing multiple simultaneous touches, the method comprising the steps of:
Connecting the controller to a remotely controllable device;
touching the touchscreen display at a first location with a first finger to provide a first input that initiates a function;
touching the touchscreen display at a second location with a second finger;
moving the second finger in a direction away from the second location to a third location to provide a second input to the function;
converting the first and second input by the processor into a command signal formatted to execute the function locally in the controller or remotely in a remotely controllable device;
executing the function in response to the command signal; and
displaying on the touchscreen controller an indication associated with the executed function.

18. The method of claim 17, further comprising the step of:
touching the touchscreen display with a plurality of fingers to provide the first input or the second input.

19. The method of claim 17, the controller further having a means for sensing motion, further comprising the step of combining one or more motions with the first input or second input to activate or control a function.

17. method of claim 17, further comprising the steps of:
transmitting the command signal to the remotely controllable device;
receiving a signal from the remotely controllable device by the controller in response to the command signal;
